(19) United States
(12) Patent Application Publication
(10) Pub. No.: US 2018/0365319 A1
(43) Pub. Date: Dec. 20, 2018

(54) IDENTIFYING RELATIONSHIPS FROM COMMUNICATION CONTENT

(71) Applicant: MICROSOFT TECHNOLOGY LICENSING, LLC, Redmond, WA (US)

(72) Inventors: Nikrouz GHOTBI, Redmond, WA (US); Christian LIENSBERGER, Seattle, WA (US)

(21) Appl. No.: 15/625,911

(22) Filed: Jun. 16, 2017

(51) Int. Cl. G06F 17/30; G10L 15/22; G10L 15/18; G06F 17/27

(52) U.S. Cl. CPC G06F 17/30684; G06F 17/30864; G10L 15/22; G10L 2015/088; G06F 17/277; G06F 17/278; G10L 2015/223; G10L 15/1815

(57) ABSTRACT

Systems and methods for inferring relationships between a target person and another entity according to accessed or captured communication content of the target person are presented. Various communications (communication content) of a target person are accessed or captured. Communication content is analyzed to identify key terms and/or key phrases of the captured communication content. Based, at least, on the identified key terms and key phrases, one or more relationships between the target person and another entity are inferred. A relationship record of the target person is updated with information regarding the inferred relationship.

### BACKGROUND

Computer-implemented digital assistants, such as Microsoft's Cortana and Apple's Siri, have risen in use and popularity. Generally speaking, a person will direct a request to the digital assistant that, in turn, attempts to determine the intent of the request and, to the best of its ability, respond with a corresponding action, including providing information to the requesting person, setting reminders, adding data to an online calendar, and the like.

Of course, digital assistants are limited in the assistance that they can provide by the information and abilities that they have at their disposal. The better, and more robust information that a digital assistant has to access, the better and more complete can be the digital assistant's response to a given request. By way of a simple example, if a digital assistant did not have a way to determine the current time, it could not satisfactorily respond to a person's request, “what time is it?” Of course, most digital assistants actually do have the ability to determine the current time. However, there is a substantial amount of information that is not available to digital assistants, especially personal and/or relationship information. Indeed, a simple query such as, “what day is my parents' anniversary?” will likely go unanswered due, at least in part, to the fact that the information about (1) who are the parents, and (2) when is their anniversary is not known or available.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems and methods for inferring relationships between a target person and another entity according to accessed or captured communication content of the target person are presented. Various communications (communication content) of a target person are accessed or captured. Communication content is analyzed to identify key terms and/or key phrases of the captured communication content. Based, at least, on the identified key terms and key phrases, one or more relationships between the target person and another entity are inferred. A relationship record of the target person is updated with information regarding the inferred relationship.

According to additional aspects of the disclosed subject matter, a computer-implemented method for inferring relationship information between a target person and another entity according to communication content of the target user is presented. The method includes accessing at least one item of communication content of the target person. The accessed communication content is then analyzed to extract key terms and key phrases within the communication content. The extracted key terms and key phrases are analyzed in regard to the target person to infer at least one relationship between the target person and an entity. A relationship record corresponding to the target person is then updated with information regarding the at least one inferred relationship.

According to additional aspects of the disclosed subject matter, computer-readable medium bearing computer-executable instructions for carrying out a method inferring relationship information between a target person and another entity according to communication content of the target user is presented. The method includes accessing at least one item of communication content of the target person. The accessed communication content is then translated to a standard format for analysis. The communication content is then analyzed to extract key terms, key phrases and intents within the communication content. The extracted key terms, key phrases and intents are analyzed in regard to the target person to infer at least one relationship between the target person and an entity. A relationship record corresponding to the target person is then updated with information regarding the at least one inferred relationship.

According to still further aspects of the disclosed subject matter, computer system for inferring relationship information for a plurality of target persons is presented. The computer system comprises, at least, a processor and a memory, wherein the processor executes instructions stored in the memory as part of or in conjunction with additional components to infer a relationship between a target person and another entity according to communication content of the target person. The additional components include, at least a communication analysis module and a relationship manager. The communication analysis module, in execution, is configured to access communication content of the target person, and translate the accessed communication content to a standard format for analysis. The communication analysis module further analyzes the accessed communication content to extract key terms, key phrases and intents within the target person's communication content. The relationship manager, in execution on the computer system, analyzes the extracted key terms, key phrases and intents in regard to the target person and infers at least one relationship between the target person and an entity according to the analysis. Additionally, the relationship manager updates a relationship record corresponding to the target person with information regarding the at least one inferred relationship

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating a flow of information from capturing communication content to generating and/or updating relationship information of a person;

FIG. 2 is a flow diagram illustrating an exemplary computer-implemented routine for processing communication content;

FIG. 3 is a block diagram illustrating an exemplary computer readable medium encoded with instructions for inferring relationship data from captured/accessed communication content, as described in regard to FIG. 2;

FIG. 4 is a block diagram of a computing device suitable for implementing aspects of the disclosed subject matter; and

FIG. 5 is a block diagram illustrating an exemplary network environment 500 suitable for implementing aspects of the disclosed subject matter.

### DETAILED DESCRIPTION

For purposes of clarity and definition, the term “exemplary,” as used in this document, should be interpreted as serving as an illustration or example of something, and it should not be interpreted as an ideal or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users. Moreover, the use of the combination “and/or” with regard to multiple items should be viewed as meaning either or both items.

As will be described in greater detail below, based on information identified from monitoring communications and other signals of a target person, relationships between the target person and topics, entities and the like are generated and/or updated. For purposes of facilitating legibility, while relationships may be identified between the target person and other things including, by way of illustration and not limitation: topics; intellectual, social and/or religious positions; organizations and/or affiliations; persons; entities; and the like, collectively these various things with which the target person is related are generically referred to as “entities.” In short, for purposes of ease in reading, the disclosed subject matter will be described in terms of generating and maintaining relationships between a target person and other entities.

According to aspects of the disclosed subject matter, communication content between a target person and one or more other persons is accessed and evaluated. The communication content is access or obtained from a variety of communication content sources. By way of illustration and not limitation, these communication content sources may include any one or more of: ambient devices (i.e., listening devices and or processes whose purpose is to process conversational content in which the target person is—or may be—participating) that listen to conversations that include the target person; audio and/or audio/video teleconferencing systems; telecommunication systems; text messaging systems; e-mail systems; social media services; and the like.

After accessing an item of communication content (e.g., a conversation, a meeting, an email, etc.), an analysis process is conducted to identifies key terms, phrases and intents that can be used in inferring relationships between the target person and entities, as well as information such as the nature or basis of these relationships, the strength (if applicable) of a particular relationship, and the like. The analysis process identifies the various key terms according to any one of a variety of techniques including, by way of illustration and not limitation, key-word matching on one or more lexicons and/or ontologies, lexical analysis using tf-idf (term frequency—inverse document frequency), explicit and/or latent semantic analysis, latent semantic indexing, statistical analysis of key terms/words, and the like. The analysis process may be conducted by one or more modules that are suitably adapted according to the type or nature of communication content that is accessed or obtained. Additionally, additional key terms and related information (e.g., topics, other persons in conversation, participants of a meeting, a topic of a meeting, distribution lists of an email, and the like) may also be identified according to metadata related to the accessed/obtained communication content

The key terms and related information are then passed to a relationship manager that processed the key terms and related information to generate inferences with regard to relations of the target person with other entities. These inferences may be further based on relationship information that has already been determined and/or inferred with regard to the target user, as well as the bases for which these existing relationships have been established. In various non-exclusive embodiments, the bases of a relational inference between the target person and an entity may also be associated with that relationship. These bases may be based on a variety of factors including, by way of illustration only, frequency, duration of relationship, conversations, user confirmations, external data sources (corporate organization), overall frequency of use of key terms, amount of time spent in conversations relating to the key terms etc.

Additionally, confidence values may also be associated with the various relationships of a target person to another entity, indicating the strength of confidence of any given relational inference. In one embodiment, the relationship information between the target person and other entities is maintained as a graph of nodes, where each node represents either the target person or an entity, and the linkage between two nodes (i.e., the target person and another entity) represents the relation of the target person to that entity. Relational inferences, confidence values regarding relationships, and the like are made according to a variety of heuristics and/or techniques as implemented by the relationship manager. The relationship manager may employ any one or more of machine learning algorithms, deep learning techniques, and/or other artificial intelligence techniques in making the relational inferences between the target person and another entity. In addition to the key terms and related information, other information that may be applied and/or used in making relationship inferences include, by way of illustration and not limitation: time spent using an application, location information, telephone calls to and from others.

In addition to utilizing information from communications and according to various aspects of the disclosed subject matter, other sources of information may also be used in inferring relationship information between a target user and other entities. These additional sources of information and data may include, illustratively, corporate information and data, personal profile information, relationship graphs of other parties, and the like.

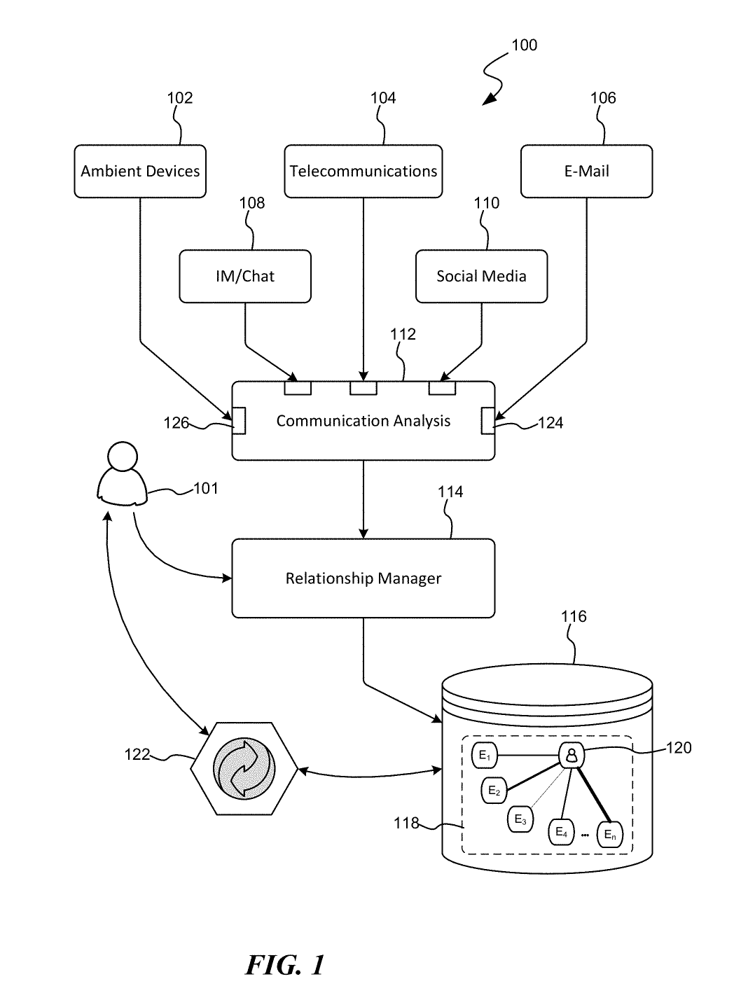

Turning now to the figures, FIG. 1 is a pictorial diagram illustrating a flow 100 of information from capturing communication content to generating and/or updating relationship information of a person. Indeed, various sources 102-110 of communication content are accessed for communication content relating to a target person 101. These sources include, by way of illustration and not limitation, ambient devices that are capable of capturing audio and/or audio-visual content of the target person, telecommunication systems that the target person utilizes to communication with one or more other persons, e-mail systems, Instant Messaging (IM) and/or chat systems, social media sites, and the like.

Communication content is accessed or captured by these communication sources 102-110 are received by a communication analysis process 112. This communication analysis process accepts the communication content of the target person and extract key words and/or phrases from the communication content, as well as determining the particular intent of the captured communication content. To do this, the communication analysis process 112 may utilize one or more translation modules, such as translation module 124, to translate the communication content from a first format to one that is suitable for identifying the key words, phrases and detecting or inferring communication intent. For instance, translation module 126 may be configured to translate captured audio communications into a standard, text-based format.

As mentioned above, the communication analysis process 112 identifies the various key and/or phrases terms from the accessed or captured communication content according to any one of a variety of techniques including, by way of illustration and not limitation, key-word or key-phrase matching on one or more lexicons and/or ontologies, lexical analysis according to TF-IDF techniques, explicit and/or latent semantic analysis, latent semantic indexing, statistical analysis of key terms, words and phrases, and the like. Additionally, additional related information (e.g., topics, contact information, other persons in conversation, participants of a meeting, the date of the communication, location of the target person of the time of the communication, the type of device being utilized by the target person to communicate, a topic of a meeting, distribution lists of an email, and the like) may also be identified according to metadata related to the accessed/obtained communication content as their presence or participation in the captured communication may serve as key data points in inferring relationship information.

After identifying the key terms, phrases and/or intents, as well as the related metadata that may be determined from the captured communication, this set of data is then provided to a relationship manager 114 where inferences regarding the target person to other entities is conducted. These inferences may be made according to a variety of factors including, by way of illustration only, frequency of mention, duration of relationship, duration of the captured communication, user confirmations, external data sources (corporate organization), existing relationship information of the target person as well as relationship information of other persons, overall frequency of use of key terms, phrases or intents, amount of time spent in conversations relating to the key terms, and the like. In addition to establishing or updating inferred relationships between the target person and other entities, the bases upon which each relationship is established may also be included with the relationship. Further still, confidence values indicating the confidence of the inferred relationship may also be included. Relationships between entities may be based on any number of relation types, such as (by way of illustration and not linnitation), “is spouse to,” “is an expert at,” “currently works at,” “is a friend of,” “enjoys,” and the like.

As relationship inferences are generated or updated, the information is added to a relationship record 118 corresponding to the target person stored in a data store, such as data store 116. As indicated above and according to aspects of the disclosed subject matter, the relationship information may be stored as a graph of nodes between the target user, as represented by node 120, and other entities, such as entities E₁-Eₙ. Moreover, as illustrated in FIG. 1, the relationships illustrated as the arcs or lines connecting the various nodes, may correspond to a strength and/or confidence of the inferred relationship, as indicated by the varying weights of the lines. Of course, a relationship between the target person and entity, such as entity Eₙ, may reflect multiple relation types. For example, the relationship between the target user (as represented by node 120) and entity Eₙ may indicate that they are co-workers, that they are also friends, and that they are working on the same project. Of course, in an alternative embodiment, a relationship between a target person and an entity may represent a single type of relationship. In such embodiments, the representative graph may include multiple lines or arcs between the target user and a specific entity.

Once a target person's relationship record is established, a digital assistant 122 may be queried by the target person 101 to respond to various queries and/or requests based, at least in part, according to the relationship information of the target person as well as relationship information of other persons or entities.

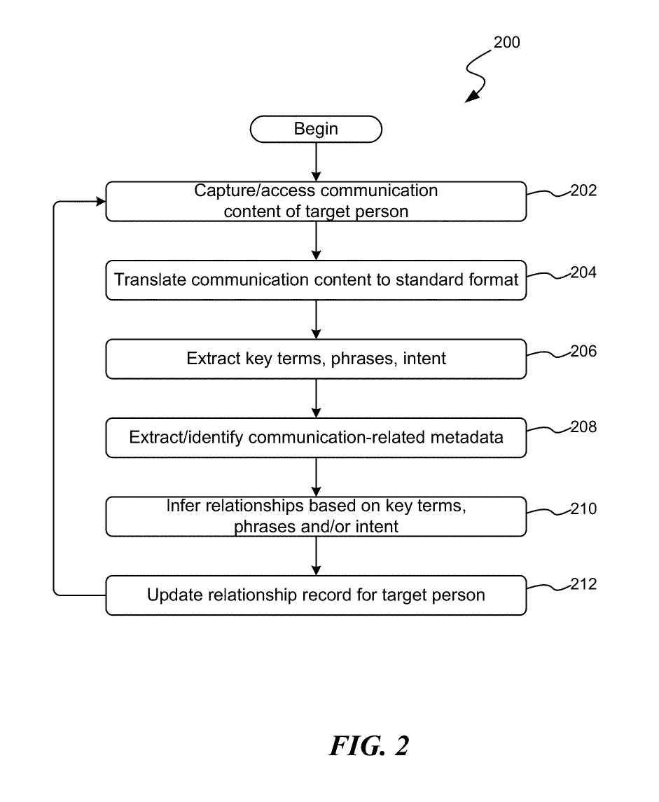

Turning now to FIG. 2, FIG. 2 is a flow diagram illustrating an exemplary computer-implemented routine 200 for processing communication content. Beginning at block 202, the exemplary routine 200, as implemented on a suitably configured computer or computing device including at least a processor, captures or accesses communication content of the target person from a communication source, such as communication source 102 of FIG. 1.

At block 204, the captured communication content is optionally translated to a standard format for further processing. Translating the captured communication content may be source dependent, depending on the current format of the content as well as the structure and/or organization of the content, including encapsulating structure and data. For instance, a captured e-mail may require extracting the communication data from the e-mail “envelope”, or translating an audio recording of a meeting to a textual transcript.

At block 206, an analysis of the communication content is carried out, the result of which is a set of key terms and/or phrases, various intents, etc. of the captured communication content. As mentioned above, this analysis may include one or more of key-word or key-phrase matching on one or more lexicons and/or ontologies, lexical analysis according to TF-IDF techniques, explicit and/or latent semantic analysis of the communication content, latent semantic indexing, statistical analysis of key terms, words and phrases, and the like. At block 208, as an additional part of the analysis, related information (e.g., topics, contact information, other persons in conversation, participants of a meeting, the date of the communication, location of the target person of the time of the communication, the type of device being utilized by the target person to communicate, a topic of a meeting, distribution lists of an email, and the like) may also be identified during the analysis according to elements of the communication content as well as metadata related to the accessed/obtained communication content as their presence or participation in the captured communication may serve as key data points in inferring relationship information.

At block 210, the extracted terms, phrases, intents and related data is again analyzed to infer relationship information between the target person and one or more entities. As part of the process, a relationship record 118 corresponding to the target person may be generated and/or updated according to the relationship analysis process of block 210. These relational inferences may be made according to a variety of factors including, by way of illustration only, frequency of mention, duration of relationship, duration of the captured communication, user confirmations, external data sources (corporate organization), existing relationship information of the target person as well as relationship information of other persons, overall frequency of use of key terms, phrases or intents, amount of time spent in conversations relating to the key terms, and the like. In addition to establishing or updating inferred relationships between the target person and other entities, the bases upon which each relationship is established may also be included with the relationship. Further still, confidence values indicating the confidence of the inferred relationship may also be included. Relationships between entities may be based on any number of relation types, such as (by way of illustration and not limitation), “is spouse to,” “is an expert at,” “currently works at,” “is a friend of,” “enjoys,” and the like.

At block 212, the relationship record 118 corresponding to the target person is updated according to the various inferences generated by the relationship analysis process of block 210. For purposes of this disclosure, updating the relationship record may include creating a relationship record for the target person if one does not already exist or, alternatively, updating the existing relationship record of the target person with inferences gained through the analyses of the communication content. Inferences made during analysis that already exist in the target person's relationship record may be updated to reflect the additional inference which may cause the confidence level of the inference to be increased, as well as adding an additional basis of the inference in the relationship record 118.

Thereafter, the routine 200 returns to block 202 where additional communication content of the target person is captured and processed, as described above.

Regarding routine 200 described above, as well as other processes that may be described herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

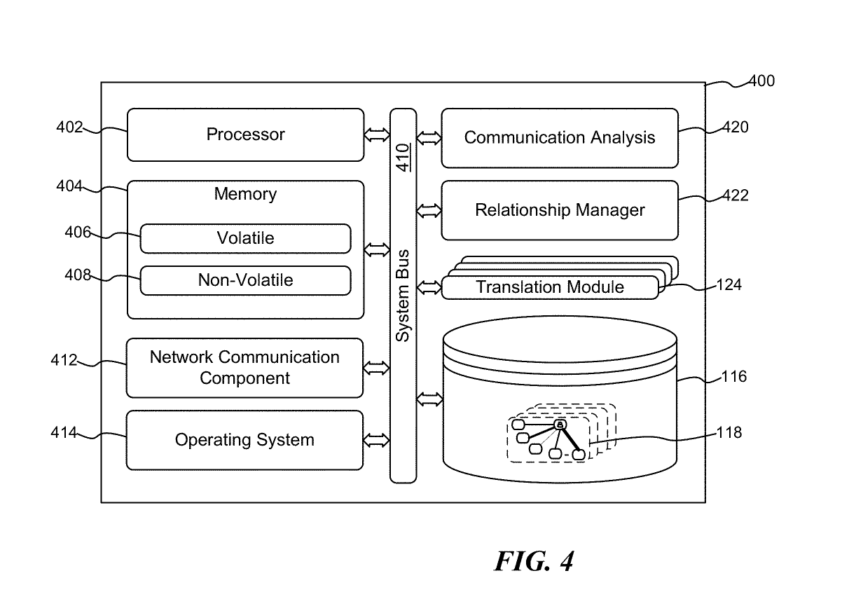

Of course, while the routines and/or processes include various novel features of the disclosed subject matter, other steps (not listed) may also be included and carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 4 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer readable media may reproduce and/or cause to deliver the computer executable instructions and data to a computing device for execution by one or more processors via various transmission means and mediums, including carrier waves and/or propagated signals, for purposes of this disclosure computer readable media expressly excludes carrier waves and/or propagated signals.

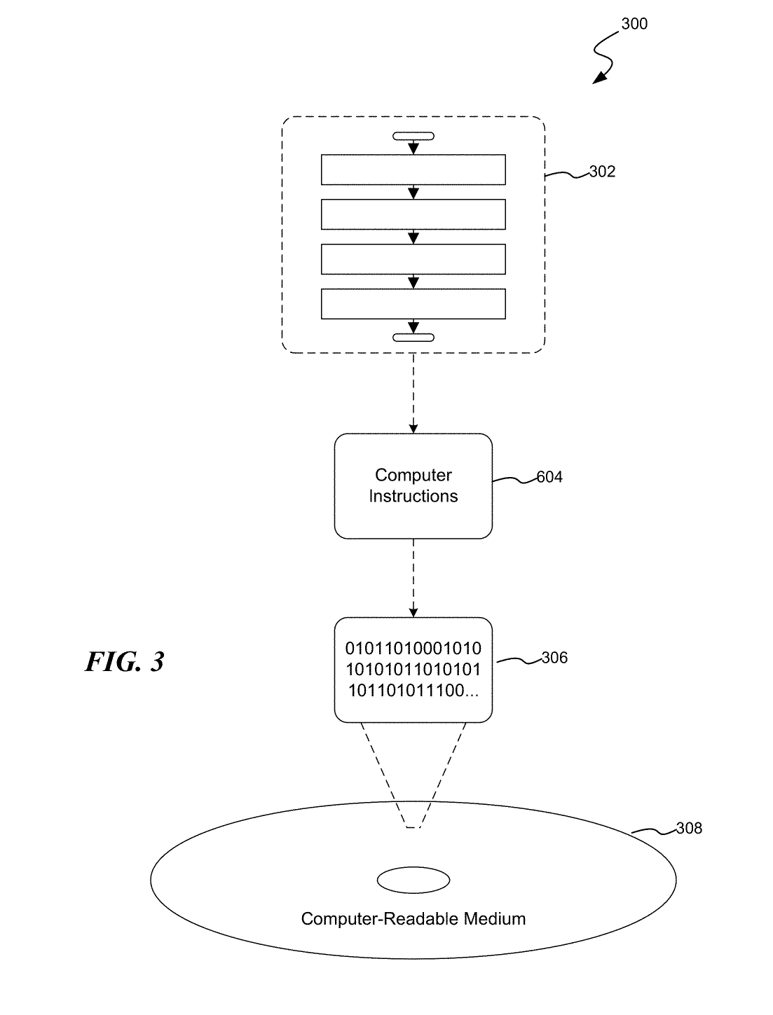

Regarding computer readable media, FIG. 3 is a block diagram illustrating an exemplary computer readable medium encoded with instructions for inferring relationship data from captured/accessed communication content, as described in regard to FIG. 2. More particularly, the implementation 300 comprises a computer-readable medium 308 (e.g., a CD-R, DVD-R or a platter of a hard disk drive), on which is encoded computer-readable data 306. This computer-readable data 306 in turn comprises a set of computer instructions 304 configured to operate according to one or more of the principles set forth herein. In one such embodiment 302, the processor-executable instructions 304 may be configured to perform a method, such as at least some of exemplary method 200, for example. In another such embodiment, the processor-executable instructions 304 may be configured to implement a system on a computing device, such as at least some of the exemplary, executable components of system 400, as described below. Many such computer readable media may be devised, by those of ordinary skill in the art, which are configured to operate in accordance with the techniques presented herein.

Turning now to FIG. 4, FIG. 4 is a block diagram of a computing device 400 suitable for implementing aspects of the disclosed subject matter. In particular, the computing device 400 may be a general purpose that, by the execution of the various components described below, transforms the computing device 400 into a specialized computer or computing device to carry out the functionality of analyzing communication content of the target person to infer or generate relationship information of the target user.

The computing device 400 includes one or more processors (or processing units), such as processor 402, and further includes at least one memory 404. The processor 402 and memory 404, as well as other components, are interconnected by way of a system bus 410. As will be appreciated by those skilled in the art, the memory 404 typically (but not always) comprises both volatile memory 406 and non-volatile memory 408. Volatile memory 406 retains or stores information so long as the memory is supplied with power. In contrast, non-volatile memory 408 is capable of storing (or persisting) information even when a power supply is not available. Generally speaking, RAM and CPU cache memory are examples of volatile memory 406 whereas ROM, solid-state memory devices, memory storage devices, and/or memory cards are examples of non-volatile memory 408.

As will also appreciated by those skilled in the art, the processor 402 executes instructions retrieved from the memory 404, from computer readable media, such as computer readable media 300 of FIG. 3, and or other executable components in carrying out various functions of inferring relationship information of a target person from captured communication content. The processor 402 may be comprised of any of a number of available processors such as single-processor, multi-processor, single-core units, and multi-core units, which are well known in the art.

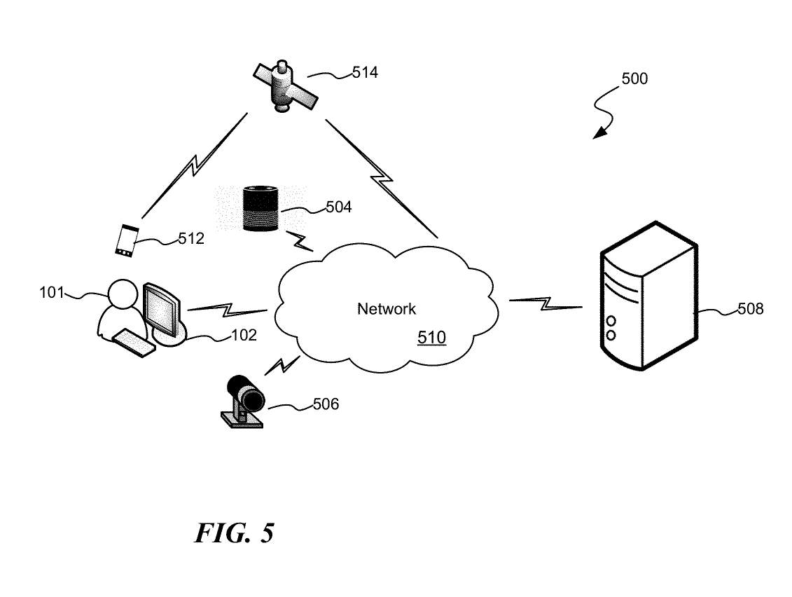

Further still, the illustrated computing device 400 typically also includes a network communication component 412 for interconnecting this computing device with other devices and/or services over a computer network, such as network 510 of FIG. 5. The network communication component 412, sometimes referred to as a network interface card or NIC, communicates over a network using one or more communication protocols via a physical/tangible (e.g., wired, optical fiber, etc.) connection, a wireless connection such as WiFi or Bluetooth communication protocols, or both. As will be readily appreciated by those skilled in the art, a network communication component, such as network communication component 412, is typically comprised of hardware and/or firmware components (and may also include or comprise executable software components) that transmit and receive digital and/or analog signals over a transmission medium (i.e., the network.)

In addition to the various component identified above, the computing device 400 further includes an operating system 414 that provide system software for the computing device, which manages both hardware and software resources of the computer. As will be appreciated by those skilled in the art, the operating system also provides a common set of services for the execution of executable modules, including applications, services, drivers, daemons, processes, and the like, on the computing device 400.

Additionally included in the computing device 400 is an executable communication analysis module 420. As described above in regard to FIG. 1, the communication analysis module 420, in execution, carries out the accepts the communication analysis process that analyzes communication content of the target person and extracts key words and/or phrases from the content, as well as potentially determining one or more intents of the captured communication content. Indeed, in execution the communication analysis module 420 identifies the various key and/or phrases terms from the accessed or captured communication content according to any one of a variety of techniques including, by way of illustration and not limitation, key-word or key-phrase matching on one or more lexicons and/or ontologies, lexical analysis according to TF-IDF techniques, explicit and/or latent semantic analysis, latent semantic indexing, statistical analysis of key terms, words and phrases, and the like. Additionally, additional related information (e.g., topics, contact information, other persons in conversation, participants of a meeting, the date of the communication, location of the target person of the time of the communication, the type of device being utilized by the target person to communicate, a topic of a meeting, distribution lists of an email, and the like) may also be identified according to metadata related to the accessed/obtained communication content as their presence or participation in the captured communication may serve as key data points in inferring relationship information.

As mentioned above, the communication analysis module may rely upon one or more translation modules, such as translation module 124, to translate the communication content from a first format to one that is suitable for identifying the key words, phrases and detecting or inferring communication intent. For instance, translation module 124 may be configured to translate captured audio communications into a standard, text-based format.

Still further included in the illustrated computing device 400 is an executable relationship manager 422. The relationship manager 422, in execution, determines inferences regarding the target person to other entities. These inferences may be made according to a variety of factors including, by way of illustration only, frequency of mention, duration of relationship, duration of the captured communication, user confirmations, external data sources (corporate organization), existing relationship information of the target person as well as relationship information of other persons, overall frequency of use of key terms, phrases or intents, amount of time spent in conversations relating to the key terms, and the like. In addition to establishing or updating inferred relationships between the target person and other entities, the bases upon which each relationship is established may also be included with the relationship. Further still, confidence values indicating the confidence of the inferred relationship may also be included. Relationships between entities may be based on any number of relation types, such as (by way of illustration and not limitation), “is spouse to,” “is an expert at,” “currently works at,” “is a friend of,” “enjoys,” and the like.

As relationship inferences are generated or updated, the information is added to a relationship record 118 of the target person that is stored in a data store, such as data store 116. Of course, the illustrated computing device 400 will typically include relationship records for a plurality of target persons, and may utilize the various relationship records to create relational inferences among/between the target persons. As indicated above and according to aspects of the disclosed subject matter, the relationship information may be stored as a graph of nodes between the target user.

Regarding the various components of the illustrated computing device 400, those skilled in the art will appreciate that many of these components may be implemented as executable software modules stored in the memory of the computing device, as executable hardware modules and/or components (including SoCs—systems on a chip), or a combination thereof. Indeed, components may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions and features described herein.

While aspects of the disclosed subject matter may be implemented on a target person's own computing device, in various embodiments the various analyses are implemented by one or more remotely located (to the target person) computing devices. In this regard, FIG. 5 is a block diagram illustrating an exemplary network environment 500 suitable for implementing aspects of the disclosed subject matter. According to aspects of the disclosed subject matter, a target person, such as target person 101, may use any number of devices, such as a computer 102, a phone 512, smart speaker 104, telecommunication equipment 106, and the like, each of which may be communicatively connected to the network 510 (as shown) or, alternatively, to the target person's computing device 102.

Regarding the network 510, a suitable network may include a variety of computer related communications networks including the Internet (i.e., a global system of interconnected computer networks that use the Internet protocol suite (TCP/IP) to link devices), local area networks, wide area networks, and the like. As illustrated in FIG. 5, the smart speaker 504 and the telecommunication equipment 506 each communicate over the network 510. A process executing on a suitably configured server computer, such as server computer 508, obtains communication content regarding the target person 101 from any or all of the computing device 102, the smart speaker 504, telecommunication equipment 506, as well as ambient devices such as the target person's mobile phone 512. Of course, not all devices must use the same network, such as network 510, in communicating with the server computer 508. For example, mobile phone 512 may provide communication content of the target user over a satellite based network 514, or a combination networks (as illustrated.)

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method as executed on a computer system comprising at least a process, the method comprising:
accessing communication content of a target person;
analyzing the accessed communication content to extract key terms and phrases within the communication content;
analyzing the extracted key terms and phrases in regard to the target person to infer at least one relationship between the target person and an entity; and
updating a relationship record corresponding to the target person with information regarding the inferred at least one relationship.

2. The computer-implemented method of claim 1, further comprising translating the accessed communication content to a standard format for analysis.

3. The computer-implemented method of claim 2, wherein the standard format for analysis is a textual format.

4. The computer-implemented method of claim 2, wherein analyzing the accessed communication content to extract key terms and phrases within the communication content further comprises analyzing the accessed communication content to extract key terms, phrases and intents within the communication content.

5. The computer-implemented method of claim 4, wherein analyzing the extracted key terms and phrases in regard to the target person to infer at least one relationship between the target person and an entity further comprises analyzing the extracted key terms, phrases and intents in regard to the target person to infer at least one relationship between the target person and an entity.

6. The computer-implemented method of claim 5, wherein updating the relationship record corresponding to the target person with information regarding the inferred at least one relationship further comprises updating the relationship record corresponding to the target person with information regarding the inferred at least one relationship and with the bases for which the at least one relationships was inferred.

7. The computer-implemented method of claim 5, wherein updating the relationship record corresponding to the target person with information regarding the inferred at least one relationship further comprises updating the relationship record corresponding to the target person with a confidence value indicating a confidence that the inferred relationship of the target person to another entity is accurate.

8. The computer-implemented method of claim 7, wherein accessing communication content of the target person comprises accessing communication content of the target person from a communication content source associated with the target person.

9. The computer-implemented method of claim 8, wherein the communication content source associated with the target person comprises any one of an ambient device, a telecommunication system, an instant messaging system, and an e-mail system.

10. The computer-implemented method of claim 9, wherein analyzing the extracted key terms, phrases and intents in regard to the target person to infer at least one relationship between the target person and an entity comprises utilizing any one or more of key-word matching on one or more lexicons, lexical analysis using tf-idf (term frequency—inverse document frequency), explicit semantic analysis, latent semantic analysis, latent semantic indexing, and statistical analysis of key terms/words.

11. A computer-readable medium bearing computer-executable instructions which, in execution on a computing system by a processor, carry out a method, comprising:
accessing communication content of a target person;
translating the accessed communication content to a standard format for analysis;
analyzing the accessed communication content to extract key terms and phrases within the communication content;
analyzing the extracted key terms and phrases in regard to the target person to infer at least one relationship between the target person and an entity; and
updating a relationship record corresponding to the target person with information regarding the inferred at least one relationship.

12. The computer-readable medium of claim 11, wherein analyzing the accessed communication content to extract key terms and phrases within the communication content further comprises analyzing the accessed communication content to identify one or more intents of the communication content.

13. The computer-readable medium of claim 12, wherein analyzing the extracted key terms and phrases in regard to the target person to infer at least one relationship between the target person and an entity further comprises analyzing the extracted key terms, phrases and intents in regard to the target person to infer at least one relationship between the target person and an entity.

14. The computer-readable medium of claim 13, wherein updating the relationship record corresponding to the target person with information regarding the inferred at least one relationship further comprises updating the relationship record corresponding to the target person with information regarding the inferred at least one relationship and with the bases for which the at least one relationships was inferred.

15. The computer-readable medium of claim 14, wherein updating the relationship record corresponding to the target person with information regarding the inferred at least one relationship further comprises updating the relationship record corresponding to the target person with a confidence value indicating a confidence that the inferred relationship of the target person to another entity is accurate.

16. The computer-readable medium of claim 15, wherein analyzing the extracted key terms, phrases and intents in regard to the target person to infer at least one relationship between the target person and an entity comprises utilizing any one or more of key-word matching on one or more lexicons, lexical analysis using tf-idf (term frequency—inverse document frequency), explicit semantic analysis, latent semantic analysis, latent semantic indexing, and statistical analysis of key terms/words.

17. The computer-readable medium of claim 16, wherein accessing communication content of the target person comprises accessing communication content of the target person from a communication content source associated with the target person.

18. A computer system for inferring relationship information for a plurality of target persons, the computer system comprising a processor and a memory, wherein the processor executes instructions stored in the memory as part of or in conjunction with additional components, comprising:
a communication analysis module that, in execution on the computer system, is configured to:
access communication content of a target person;
translate the accessed communication content to a standard format for analysis; and
analyze the accessed communication content to extract key terms, key phrases and intents within the communication content; and
a relationship manager that, in execution on the computer system, is configured to:
analyze the extracted key terms, key phrases and intents in regard to the target person and infer at least one relationship between the target person and an entity according to the analysis; and
update a relationship record corresponding to the target person with information regarding the at least one inferred relationship.

19. The computer system of claim 18, wherein the relationship manager is further configured to update the inferred relationship in the relationship record corresponding to the target person with the bases for which the at least one relationships was inferred.

20. The computer system of claim 19, wherein the communication analysis module analyzes the accessed communication content utilizing any one or more of key-word matching based on one or more lexicons, lexical analysis using tf-idf (term frequency—inverse document frequency), explicit semantic analysis, latent semantic analysis, latent semantic indexing, and statistical analysis of key terms/words.
